(19) United States
(12) Patent Application Publication
(10) Pub. No.: US 2025/0378808 A1
(43) Pub. Date: Dec. 11, 2025

(54) SOUND SOURCE, COMPUTER-IMPLEMENTED METHOD FOR CONTROLLING SOUND SOURCE, NON-TRANSITORY COMPUTER-READABLE STORAGE MEDIUM, AND ELECTRONIC KEYBOARD INSTRUMENT

(71) Applicant: YAMAHA CORPORATION, Hamamatsu-shi (JP)

(72) Inventor: Masatsugu OKAZAKI, Hamamatsu-shi (JP)

(21) Appl. No.: 19/310,135

(22) Filed: Aug. 26, 2025

Related U.S. Application Data
(63) Continuation of application No. PCT/JP2024/003479, filed on Feb. 2, 2024.

(30) Foreign Application Priority Data
Feb. 27, 2023 (JP) 2023-028449

(51) Int. Cl. G10H 1/34; G10H 1/18

(52) U.S. Cl. CPC G10H 1/348; G10H 1/18; G10H 2230/065

(57) ABSTRACT

A sound source includes (i) one or more memories storing instructions and one or more processors configured to execute the instructions, (ii) one or more circuits, or both (i) and (ii) configured to: obtain a setting instruction; generate first information defining a key-damper half zone or a key-damper half point for sound production for each of a plurality of keys of an electronic keyboard instrument in accordance with the setting instruction; and output the generated first information.

### CROSS-REFERENCE TO RELATED APPLICATIONS

The present application is a continuation application of International Application No. PCT/JP2024/003479, filed Feb. 2, 2024, which claims priority to Japanese Patent Application No. 2023-028449, filed Feb. 27, 2023. The contents of these applications are incorporated herein by reference in their entirety.

### BACKGROUND

The present disclosure relates to a sound source, a computer-implemented method for controlling a sound source, a non-transitory computer-readable storage medium, and an electronic keyboard instrument.

An acoustic keyboard instrument has dampers, one for each note except for higher notes. While the dampers can be displaced all at once in response to pedal actuation, each damper can also be displaced and removed from a corresponding string in response to the depression of a corresponding key. Typically, during the key depressing stroke, a hammer strikes the string, from which the damper has been removed, to start producing sound, and during a key releasing stroke, a corresponding damper returns to contact the string so that the sound being produced is rapidly dampened.

The timings, at which the damper comes into contact with and is removed from the string during the keystroke, determine the so-called half characteristics. Generally, a rest zone, a half zone, and a string release zone are encountered during a key depressing action stroke. The rest zone defines a play zone, in which the action of the depression of the key has not yet been transmitted to the damper. The half zone refers to a zone spanning from the start of decrease of the holding force on the string by the damper to the loss of contact of the damper with the string. The string release zone represents a zone, in which the damper has been completely removed from the string. The half characteristics depend on how these zones are configured.

In the context of tactile perception with fingers, a player feels that a key is “heavy” if a damper is removed early from a string and feels that the key is “light” if the damper is removed late from the string, specifically during a key depressing stroke. Meanwhile, in terms of sound production, specifically during a key releasing stroke, the sound begins to be quickly dampened once transition occurs from the string release zone to the half zone. The damping rate further accelerates as soon as the transition from the half zone to the rest zone takes place. In this way, the player perceives by ear the manner in which the sound is silenced, in response to the key releasing action.

It should be noted that the same considerations as discussed above apply to the half characteristics for those cases where a half point is defined to internally divide the half zone at a prescribed internal division ratio. Moreover, the position of the half point is what would dictate the half characteristics in more simplified set-ups where there is essentially no half zone such that the rest zone and the string release zone are split by the half point.

However, in general, the half characteristics are fixed and cannot be modified. The fixed half characteristics may not match a player's preference. Providing variable half characteristics for sound production can open up more training possibilities, especially with electronic musical instruments.

JP 6111807 B2 discloses keyboard instruments that store damper half information for each key and generate a key travel as a function of a damper position. However, the keyboard instruments in JP 6111807 B2 do not have the ability to vary the half zone while the instruments are played.

Meanwhile, JP 3296518 B2 discloses providing variable half characteristics in terms of the relationship between a damper pedal and dampers during a pedal stroke. However, the half characteristics cannot be made variable on a key-to-key basis in JP 3296518 B2.

Devices are also known in which the timings, at which a damper comes into contact with and is removed from a string, can be physically varied (JP 2003-529806 A and JP 2012-053416 A). However, position adjustments must be made on an individual basis with these devices.

One object of the present disclosure is to provide a sound source, for which mute timings can be set as desired.

### SUMMARY

One aspect is a sound source that includes (i) one or more memories storing instructions and one or more processors configured to execute the instructions, (ii) one or more circuits, or both (i) and (ii) configured to: obtain a setting instruction; generate first information defining a key-damper half zone or a key-damper half point for sound production for each of a plurality of keys of an electronic keyboard instrument in accordance with the setting instruction; and output the generated first information.

Another aspect is a computer-implemented method for controlling a sound source to perform a process. The process includes obtaining a setting instruction; generating first information defining a key-damper half zone or a key-damper half point for sound production for each of a plurality of keys of an electronic keyboard instrument in accordance with the setting instruction; and outputting the generated first information.

Another aspect is a non-transitory computer-readable storage medium storing a program executable by at least one processor of a computer system to control a sound source to perform a process. The process includes obtaining a setting instruction; generating first information defining a key-damper half zone or a key-damper half point for sound production for each of a plurality of keys of an electronic keyboard instrument in accordance with the setting instruction; and outputting the generated first information.

Another aspect is an electronic keyboard instrument that includes the above-described sound source.

Another aspect is an electronic keyboard instrument that includes a plurality of keys; and (i) one or more memories storing instructions and one or more processors configured to execute the instructions, (ii) one or more circuits, or both (i) and (ii) configured to: obtain a setting instruction; generate first information defining a key-damper half zone or a key-damper half point for sound production for each of the plurality of keys in accordance with the setting instruction; obtain a position in a keystroke of a key among the plurality of keys; and control sound production and sound silencing based on the obtained position in the keystroke and the generated first information.

The embodiments allow mute timings to be set as desired.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 is a block diagram of a musical instrument system that includes a sound source in accordance with a first embodiment of the present disclosure;

FIG. 2 is a concept diagram of a keystroke range and a half zone within the range;

FIG. 3 is a concept diagram of a half setting information table;

FIG. 4 shows functional blocks of a sound source device as the sound source;

FIG. 5 is a flowchart of a main process;

FIG. 6 is a flowchart of a main process in accordance with a second embodiment of the present disclosure;

FIG. 7 is a block diagram of an electronic keyboard instrument in accordance with a third embodiment of the present disclosure;

FIG. 8 shows functional blocks of the electronic keyboard instrument;

FIG. 9 is a flowchart of a sound control process; and

FIG. 10 is a fragmentary cross-sectional view of an electronic keyboard instrument that focuses on a single key to illustrate how the instrument is constructed.

### DETAILED DESCRIPTION

The present specification is applicable to a sound source, a computer-implemented method for controlling a sound source, a non-transitory computer-readable storage medium, and an electronic keyboard instrument.

The embodiments will now be described with reference to the accompanying drawings, wherein like reference numerals designate corresponding or identical elements throughout the various drawings. The embodiments presented below serve as illustrative examples of the present disclosure and are not intended to limit the scope of the present disclosure.

What follows is a description of embodiments of the present disclosure, which description is made with reference to the drawings.

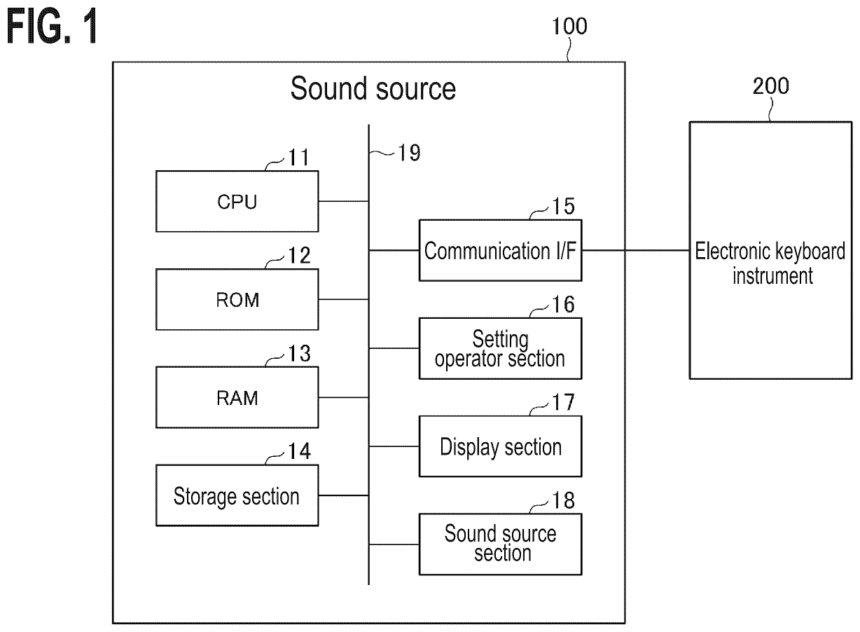

FIG. 1 is a block diagram of a musical instrument system that includes a sound source in accordance with a first embodiment of the present disclosure. The musical instrument system is formed of a sound source device 100 as a sound source according to the present disclosure and an electronic keyboard instrument 200 communicatively linked with the sound source device 100.

The electronic keyboard instrument 200 is a musical instrument capable of electronically generating sounds. The electronic keyboard instrument 200 includes a plurality of keys and sensors each configured to sense a position in a keystroke for a respective one of the keys, although both are not shown. The electronic keyboard instrument 200 also includes a variety of interfaces to communicate with the sound source device 100. Examples of such various interfaces include a MIDI-I/F for transmitting and receiving MIDI (or Musical Instrument Digital Interface) signals and an interface for transmitting and receiving audio signals.

Further, the electronic keyboard instrument 200 features a sound source functionality and a sound production functionality for converting audio signals created with the sound source functionality into sounds. The sound source functionality involves transforming play information that is provided or, otherwise, stored into audio signals. One example form of the play information is MIDI signals. The play information is primarily constituted by information generated as a result of play with the electronic keyboard instrument 200 on which the keyboard is played. The sound production functionality involves an effect circuit and a speaker (both not shown) to convert the audio signals into sound for sound production.

The sound source device 100 includes a CPU 11 and other elements including a ROM 12, a RAM 13, a storage section 14, a communication I/F (or interface) 15, a setting operator section 16, a display section 17, and a sound source section 18 in such a way that these elements are connected to the CPU 11 via a bus 19.

The CPU 11 includes a timer, although not shown. The storage section 14 assumes the form of a non-volatile memory. The ROM 12 or the storage section 14 stores a control program for execution by the CPU 11. The CPU 11 loads the control program stored in the ROM 12 or the storage section 14 into the RAM 13 and executes the same to implement the various functionalities of the sound source device 100.

The communication I/F 15 includes a MIDI-I/F. In addition, the communication I/F 15 includes an interface for transmitting and receiving audio signals. It should be recognized that the communication I/F 15 can include an interface for linking to a communication network via a wireless or cabled connection. The setting operator section 16 includes a plurality of operators, through which various information can be input, to accept commands from a user. The display section 17 provides visual representations of a variety of information.

The sound source section 18 transforms play information, which is received from the electronic keyboard instrument 200 or, otherwise, stored into audio signals. One example form of the play information is MIDI signals. The play information received from the electronic keyboard instrument 200 is primarily constituted by information generated as a result of play with the electronic keyboard instrument 200 on which the keyboard is played. It should be noted that the sound source section 18 may be entirely constituted by hardware or software, or partially constituted by software with the rest constituted by hardware.

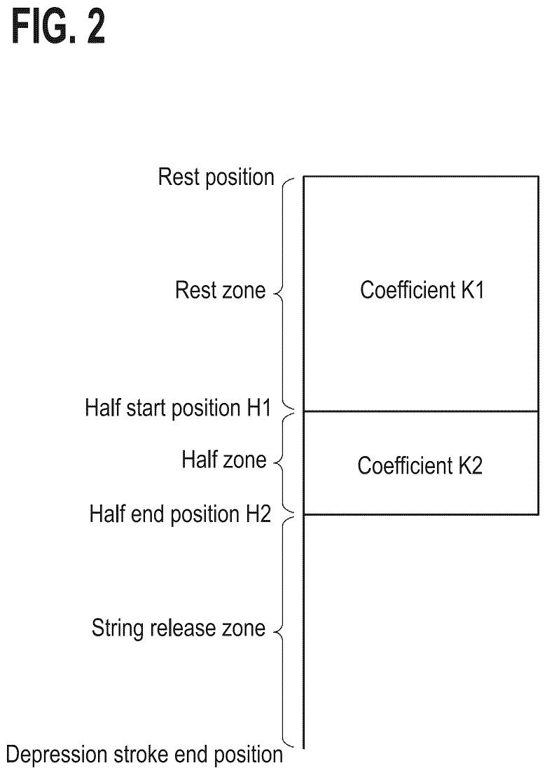

FIG. 2 is a concept diagram of a keystroke range and a half zone within the range.

For acoustic pianos, a rest zone, a half zone, and a string release zone are encountered during a key depressing action stroke. The rest zone defines a play zone, in which the action of the depression of the key has not yet been transmitted to a damper. The half zone refers to a zone spanning from the start of decrease of the holding force on a string by the damper to the loss of contact of the damper with the string. The string release zone represents a zone, in which the damper has been completely removed from the string. Half characteristics depend on how these zones are configured.

As used herein, a “key-damper half zone” refers to a half zone in terms of the relationship between a key and a damper associated with the key. Meanwhile, as used herein, a “half pedal zone” refers to a half zone in terms of the relationship between a pedal and a damper. Since it is a key-damper half zone that is focused on in the discussions on the instant embodiment, the term “half zone” will hereinafter be used to refer to a “key-damper half zone”, unless noted otherwise.

In the instant embodiment, the sound source device 100 generates half setting information J (which will be further discussed below), which, in turn, is output to the electronic keyboard instrument 200. The electronic keyboard instrument 200 creates audio signals, based on the half setting information J and the play information, to produce sounds. This set-up enables half characteristics for sound production to be varied, including mute timings (for example, a timing at which to initiate sound silencing) in the electronic keyboard instrument 200. The ability to generate half touch “feel” for tactile perception is optional for the electronic keyboard instrument 200, since providing variable half characteristics for electronic sound production is the goal. Accordingly, stings, dampers, and action mechanism are not mandatory for the electronic keyboard instrument 200.

Note that a keystroke range used to define the half setting information J is defined in line with the stroke of a finger to manipulate a key, as follows: a rest zone is defined as a zone spanning from a rest position (in other words, an initial position, at which the finger has not yet touched the key) to a half start position H1, a half zone is defined as a zone spanning from the half start position H1 to a half end position H2, and a string release zone is defined as a zone spanning from the half end position H2 to a depression stroke end position, as all shown in FIG. 2.

It should be recognized that the half zone primarily contributes to muting or sound silencing (in other words, sound damping that occurs in a period between loss of the effort on a depressed key and the return of the key to the initial position). Accordingly, the sound production trigger position that triggers sound production during a key depressing stroke is at the half end position H2 or at a deeper position than the half end position H2. Hence, during the key depressing stroke, the sound production is triggered when the position in a keystroke goes past the sound production trigger position.

It should be understood that, while the half start position H1 and the half end position H2 have been defined in terms of a depression depth from the rest position, this is merely one of the possible ways that the positions H1 and H2 can be defined. That is, the positions H1 and H2 may alternatively be defined in terms of recovery amounts from the depression stroke end position towards the rest position.

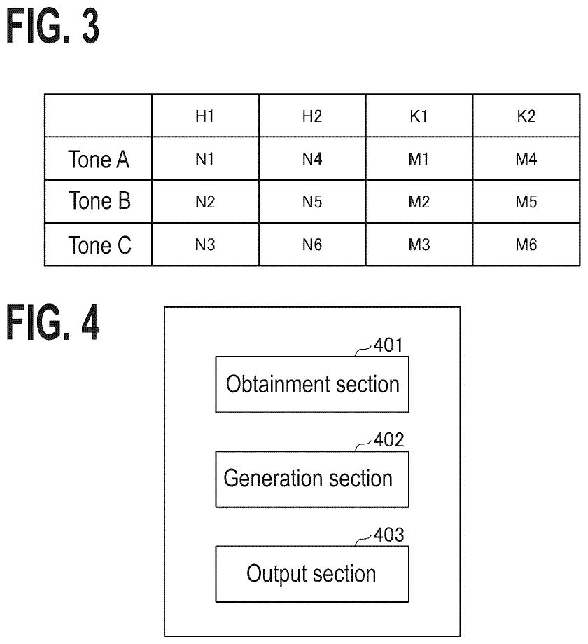

FIG. 3 is a concept diagram of a half setting information table.

The half setting information J includes a manner in which (or a damping rate at which) produced sound is silenced as a function of a position in a keystroke. In one example, the half setting information table is constituted by the half start position H1, the half end position H2, and coefficients K1 and K2, which are provided in association with each other for each tone. For instance, the half setting information table is stored in the storage section 14.

The sound source device 100 uses the half setting information table to generate the half setting information J to be output. The half setting information J to be output is constituted by information in which one tone designated by a tone setting instruction is contained in association with the corresponding values for H1, H2, K1, and K2. For example, when the one tone designated by the tone setting instruction is a tone A, the values for H1, H2, K1, and K2 would be N1, N4, M1, and M4, respectively.

The tone of sound to be produced in the electronic keyboard instrument 200 is set to either one of the tones A, B, or C as identified by the half setting information J. It should be recognized that any number and types of tones can be used from which to select the tone. Further, the values for H1, H2, K1, and K2 will determine the half characteristics of the device (or, in the instant case, the electronic keyboard instrument 200), to which the half setting information J is output, including muting.

In other words, the half setting information J will define a half zone (in other words, key-damper half zone) or a key-damper half point for sound production for each of the plurality of keys of the electronic keyboard instrument 200.

The half setting information J in the instant embodiment defines a key-damper half zone, as can be seen from the fact that the values for H1 and H2 defining a half zone are used. In contrast, some set-ups use a half point to define half characteristics. For these set-ups, a half point (or a key-damper half point) that indicates a single point is specified instead of the values for H1 and H2, to effectively establish values equivalent to those for H1 and H2 (with the aid of, for example, a prescribed internal division ratio). Therefore, for those set-ups where half characteristics are specified by a half point, the half setting information J would serve to define a key-damper half point.

The half setting information J essentially includes a command to configure sound damping rates for different zones during a releasing stroke (in other words, a stroke that starts with loss of the effort on a depressed key and lasts till transition into a non-actuated state has been complete). Such a damping rate is calculated according to the equation: “V_{damping rate}=V_{velocity during releasing stroke}×k_{coefficient}”, and the higher the damping rate is, the more rapidly sounds are dampened. For k_{coefficient}, the coefficient K2 is used to calculate a damping rate for the half zone while the coefficient K1 is used to calculate a damping rate for the rest zone (FIG. 2).

The half setting information J may also include a command to add a prescribed sound effect in order to provide a sound effect that is characteristic of the half zone. This sound effect is used to reproduce the acoustics of a string when slightly contacted by a damper.

FIG. 4 shows functional blocks of the sound source device 100 used to produce an output of the half setting information J. The sound source device 100 includes an obtainment section 401, a generation section 402, and an output section 403 as functional sections of the device. The functionalities of these various functional sections are primarily implemented by the cooperation between the CPU 11, the ROM 12, the RAM 13, the storage section 14, the setting operator section 16, and the communication I/F 15, among others.

The obtainment section 401 obtains the tone setting instruction. The tone setting instruction pertains to setting of the tone of sound played by the electronic keyboard instrument 200. In one example, the tone setting instruction is obtained by receiving an input made from the setting operator section 16 operated by a user to designate a desired tone. Alternatively, the tone setting instruction may be obtained by receiving, via the communication I/F 15, an input made by a user from the electronic keyboard instrument 200.

The generation section 402 generates the half setting information J in accordance with the tone setting instruction. The output section 403 outputs the generated half setting information J. In the instant embodiment, the output section 403 transmits, via the communication I/F 15, the half setting information J for output to the electronic keyboard instrument 200.

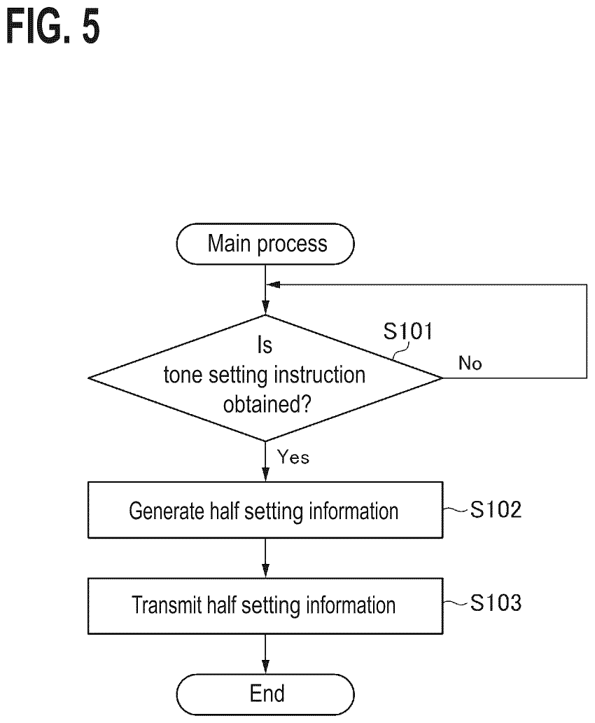

FIG. 5 is a flowchart of a main process. The process is carried out as the CPU 11 loads the program stored in the ROM 12 or the storage section 14 into the RAM 13 and executes the same. For instance, this process is triggered when the sound source device 100 is turned on.

At step S101, the CPU 11 waits until the tone setting instruction is obtained and proceeds to step S102 once the tone setting instruction is obtained. At step S102, the CPU 11 generates the half setting information J based on the tone setting instruction. Here, the CPU 11 includes, in the generated half setting information J, a command to configure a tone identified by the tone setting instruction to be the tone of sound to be produced.

For instance, when the tone setting instruction designates a “tone B”, the CPU 11 includes, in the half setting information J, a command to configure the tone B to be the tone of sound to be produced. Also, the CPU 11 sets N2, N5, M2, and M5 as the values for H1, H2, K1, and K2, respectively, in the half setting information J (FIG. 3). Further, the CPU 11 includes, in the half setting information J, a command to add a prescribed sound effect for the half zone defined by the values for H1 and H2.

At step S103, the CPU 11 transmits, via the communication I/F 15, the generated half setting information J to the electronic keyboard instrument 200 and subsequently ends the main process of FIG. 5.

Upon receiving the tone setting instruction and the half setting information J, the electronic keyboard instrument 200 carries out the following processing:

The electronic keyboard instrument 200 configures the tone of sound, which is to be produced in the sound source functionality, in accordance with the tone setting instruction as identified by the received half setting information J. Also, the electronic keyboard instrument 200 configures sound damping rates for different stroke zones encountered during a releasing stroke, in accordance with the values for H1, H2, K1, and K2 as identified by the received half setting information J. Further, the electronic keyboard instrument 200 configures a prescribed sound effect identified by the half setting information J to be added for the half zone.

Then, the electronic keyboard instrument 200 controls sound production and sound silencing according to play of the instrument. For instance, the electronic keyboard instrument 200 generates play information according to play with the keyboard. Further, the electronic keyboard instrument 200 uses the sound source functionality to create audio signals based on the configured tone of sound to be produced and the play information and uses the sound production functionality to convert the created audio signals to sounds.

For example, referring to FIG. 2, the electronic keyboard instrument 200 dampens the sounds at a rate proportional to the coefficient K2, as the position in the keystroke goes past the half end position H2 during the releasing stroke, after sound production has been triggered during the depression stroke. The electronic keyboard instrument 200 adds a designated, prescribed sound effect until the position in the keystroke reaches the half start position H1 (in other words, over the half zone). Then, once the position in the keystroke goes past the half start position H1, the electronic keyboard instrument 200 dampens the sounds at a rate proportional to the coefficient K1.

It should be noted that, if the position in the keystroke can be obtained continuously in the half zone as well, the prescribed sound effect to be added may be progressively changed as a function of the position in the stroke. Also, the sound damping rate for the half zone may be varied as a function of the position in the stroke.

According to the instant embodiment, the tone setting instruction is obtained to generate the half setting information J defining the key-damper half zone or the key-damper half point for sound production in accordance with the tone setting instruction. Then, the generated half setting information J is output. Accordingly, the manner in which sound is silenced during the releasing stroke is established in accordance with the tone setting instruction, in the electronic keyboard instrument 200, which received the half setting information J. In this way, mute timings can be set as desired. In particular, because the half setting information J includes the manner in which produced sound is silenced as a function of the position in the keystroke, variable half characteristics for sound production can be provided in accordance with the tone setting instruction.

It should be noted that, while it has been described that the electronic keyboard instrument 200 establishes sound damping rates according to the values for H1, H2, K1, and K2, the sound source device 100 may alternatively establish the sound damping rates and include, in the half setting information J, a command to configure the established damping rates for different zones during a stroke.

In the first embodiment, the electronic keyboard instrument 200 is responsible for the creation of the audio signals based on the half setting information J and the play information. In a second embodiment of the present disclosure, the sound source device 100 is responsible for the creation of the audio signals and transmission of the same to the electronic keyboard instrument 200. The electronic keyboard instrument 200 converts the audio signals into sounds. Thus, the sound source functionality is optional for the electronic keyboard instrument 200. Moreover, stings, dampers, and action mechanism are not mandatory for the electronic keyboard instrument 200.

In the instant embodiment, as in the first embodiment, the sound source device 100 includes an obtainment section 401, a generation section 402, and an output section 403 as functional sections of the device (FIG. 4). The functions of the obtainment section 401 and the generation section 402 are analogous to those in the first embodiment. In contrast, the output section 403 receives, via the communication I/F 15, the play information generated as a result of play with the electronic keyboard instrument 200 on which the keyboard is played. Further, the output section 403 creates the audio signals based on the half setting information J and the received play information and transmits, via the communication I/F 15, the created audio signals for output to the electronic keyboard instrument 200.

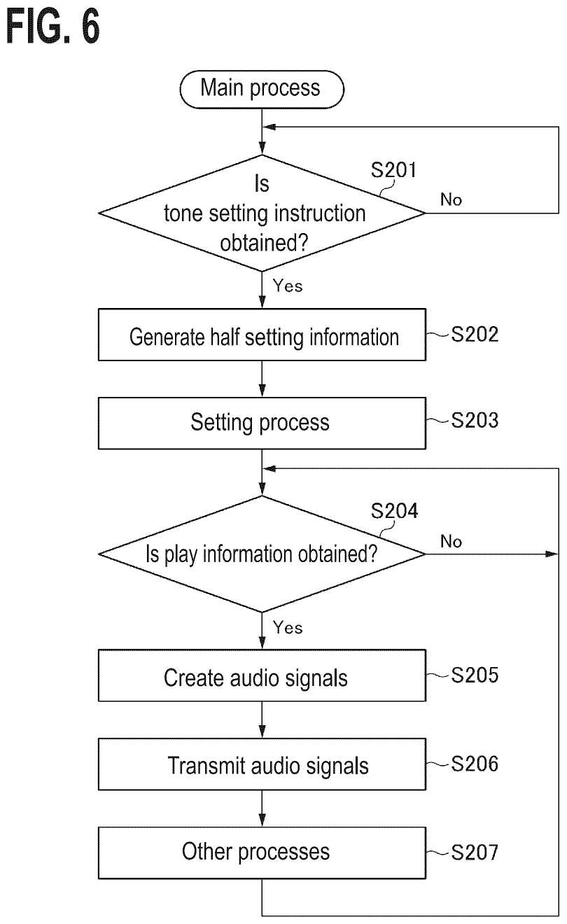

FIG. 6 is a flowchart of a main process. What is responsible for performing this process and under what conditions this process begins are identical to those in the main process shown in FIG. 5.

At steps S201 and S202, the CPU 11 performs the same processing as the steps S101 and S102 of FIG. 5. At step S203, the CPU 11 carries out a setting process. Firstly, in the setting process, the CPU 11 configures the tone of sound to be produced in the sound source section 18, in accordance with a tone command identified by the half setting information J. Also, the CPU 11 configures the sound damping rates for different zones during a releasing stroke, according to the values for H1, H2, K1, and K2 as identified by the half setting information J. Further, the CPU 11 configures the prescribed sound effect identified by the half setting information J to be added for the half zone.

At steps S204 to S207, the CPU 11 creates and transmits the audio signals in accordance with the incoming, play information from the electronic keyboard instrument 200, namely, in real time. Firstly, at step S204, the CPU 11 waits until the play information is obtained from the electronic keyboard instrument 200 and proceeds to step S205 once the play information is obtained from the electronic keyboard instrument 200. The play information referred to in this context contains the position in the keystroke and information on the velocity (in other words, a manipulation speed) during a depression stroke or releasing stroke. The position in the keystroke is obtained as a continuous quantity.

At step S205, the CPU 11 creates the audio signals based on the tone identified by the half setting information J and the obtained play information. For instance, the CPU 11 creates the audio signals for sound production upon determining that the position in the keystroke has gone past the sound production trigger position in the direction of depression (in other words, note on). Also, upon determining that the position in the keystroke has gone past the half end position H2 in the direction of release, the CPU 11 creates the audio signals in such a way that the sounds are dampened at a rate proportional to the coefficient K2, until the position in the keystroke reaches the half start position H1 (in other words, over the half zone). Further, the CPU 11 creates the audio signals in such a way that the designated, prescribed sound effect is added for the half zone. Then, upon determining that the position in the keystroke has gone past the half start position H1 in the direction of release (in other words, note off), the CPU 11 creates the audio signals in such a way that the sounds are dampened at a rate proportional to the coefficient K1.

At step S206, the CPU 11 transmits, via the communication I/F 15, the audio signals created at step S205 to the electronic keyboard instrument 200. Upon receipt of the audio signals, the electronic keyboard instrument 200 conducts sound production and sound silencing processing by converting the audio signals to sounds. Accordingly, the electronic keyboard instrument 200 carries out sound production and sound silencing in real time in accordance with play of the instrument.

At step S207, the CPU 11 performs other processes before returning to step S204. The other processes referred to in this context involve responding to another detection of operation at the setting operator section 16 and executing associated processes. For instance, the CPU 11 returns to step S202 in response to the obtainment of another tone setting instruction (namely, an instruction to change tones). a the CPU 11 ends the main process of FIG. 6 in response to receiving an input of an end command.

According to the instant embodiment, the audio signals are created based on the tone identified by the half setting information J generated in accordance with the tone setting instruction and the play information obtained from the electronic keyboard instrument 200. Then, the created audio signals are transmitted to the electronic keyboard instrument 200. In this way, the manner in which sound is silenced during the releasing stroke on the electronic keyboard instrument 200 is established in accordance with the tone setting instruction. Hence, analogous advantages to those of the first embodiment can be produced in connection with the fact that mute timings can be set as desired.

It should be noted that the present disclosure can be applied to electronic keyboard instruments in which a sound source section having analogous functions to those of the sound source device 100 in the first and second embodiments is incorporated.

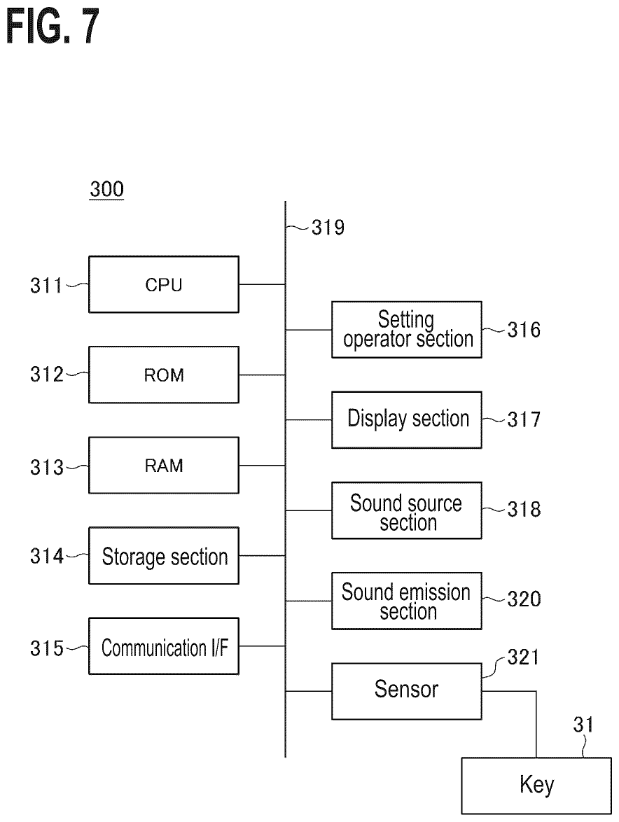

FIG. 7 is a block diagram of an electronic keyboard instrument 300 in accordance with a third embodiment of the present disclosure. The electronic keyboard instrument 300 includes a sound source section 318. For the creation of audio signals, the sound source section 318 functions analogously to those of the sound source device 100 in the second embodiment. The sound source section 318 is constituted by a built-in sound source, for example.

The electronic keyboard instrument 300 includes a CPU 311 and other elements including a ROM 312, a RAM 313, a storage section 314, a communication I/F 315, a setting operator section 316, a display section 317, the sound source section 318, a sound emission section 320, and a sensor 321 in such a way that these elements are connected to the CPU 311 via a bus 319.

The CPU 311 includes a timer, although not shown. The storage section 314 assumes the form of a non-volatile memory. The ROM 312 or the storage section 314 stores a control program for execution by the CPU 311. The CPU 311 loads the control program stored in the ROM 312 or the storage section 314 into the RAM 313 and executes the same to implement the various functionalities of the electronic keyboard instrument 300.

The communication I/F 315 includes a MIDI-I/F. In addition, the communication I/F 315 includes an interface for transmitting and receiving audio signals. It should be recognized that the communication I/F 315 can include an interface for linking to a communication network via a wireless or cabled connection. The setting operator section 316 includes a plurality of operators, through which various information can be input, to accept commands from a user. The display section 317 provides visual representations of a variety of information.

The sound source section 318 transforms play information, which is generated as a result of play with keys 31 or, otherwise, stored into audio signals. One example form of the play information is MIDI signals. It should be noted that the sound source section 318 may be entirely constituted by hardware or software, or partially constituted by software with the rest constituted by hardware. The sound emission section 320 includes an effect circuit and a speaker (both not shown) to convert the audio signals into sounds.

A plurality of keys 31 are disposed to constitute a keyboard. The sensor 321 is provided for each of the keys 31. The sensor 321 senses a position of a corresponding one of the keys 31 in the stroke and feeds the sensing result to the CPU 311.

The sensor 321 is an optical position sensor, which senses the displacement of a respective one of the keys 31 in the form of a continuous quantity and, thus, can output positions of the same in the stroke as continuous position information. For example, the sensor 321 can adopt a known configuration, in which the sensor 321 emits light towards a reflector formed with a grayscale and receives the light reflected by the reflector on a photodiode. An optical sensor is merely one of the non-limiting examples of the configuration of the sensor 321. For instance, one configuration that can alternatively be adopted involves the use of interpolation processing and/or other techniques on the instances, at which a key crosses more than one fixed location, to obtain positions of the key in a stroke in a continuous form.

Yet alternatively, the sensor 321 may be replaced with the use of a resonant circuit-based sensor such as the one disclosed in U.S. Pat. No. 7,009,648 B2, the entire content of which is incorporated herein by reference. Yet alternatively, as disclosed in WO 2017/149754 A1, the entire content of which is incorporated herein by reference, in case a configuration can be adopted in which there are multiple sites (for example, make positions) available for detection in a keystroke, the following control may be implemented; for instance, from among the multiple make positions, one or more make positions can be selected to be used for configuring the half zone or sound production and silencing timings, in accordance with the tone setting instruction.

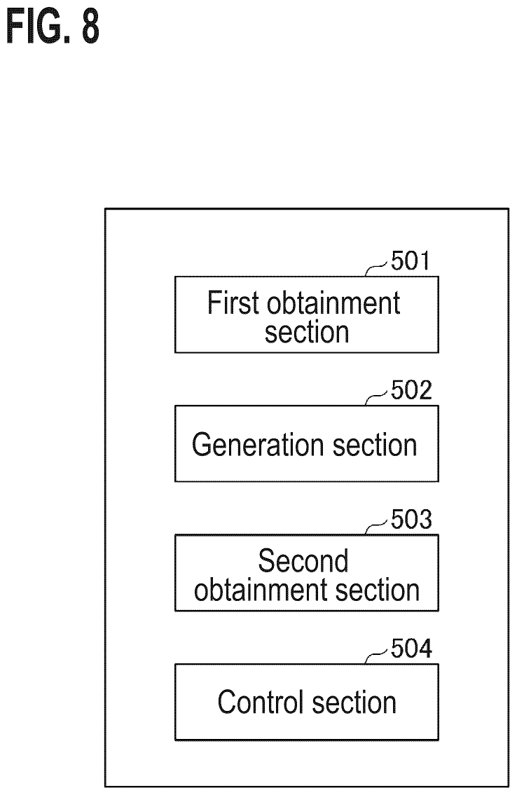

FIG. 8 shows functional blocks of the electronic keyboard instrument 300 to implement a sound control process based on the half setting information J. The electronic keyboard instrument 300 includes an obtainment section 501, a generation section 502, an obtainment section 503, and a control section 504 as functional sections of the instrument. The functionalities of these various functional sections are primarily implemented by the cooperation between the CPU 311, the ROM 312, the RAM 313, the storage section 314, the setting operator section 316, the sound source section 318, the sound emission section 321, and the sensor 321, among others.

The obtainment section 501 obtains the tone setting instruction. In one example, the tone setting instruction is obtained by receiving a command input made from the setting operator section 316 operated by a user to designate a desired tone. The generation section 502 uses a half setting information table to generate the half setting information J, in accordance with the tone setting instruction. For instance, the half setting information table is stored in the storage section 314. The obtainment section 503 obtains a position in a keystroke. The sensing result from the sensor 321 is used to obtain the position in the stroke.

The control section 504 controls sound production and sound silencing based on the obtained position in the keystroke and the generated half setting information J. For example, the control section 504 controls a manner in which produced sound is silenced, after the position in the keystroke reaches the key-damper half zone or goes past the key-damper half point during a key releasing stroke.

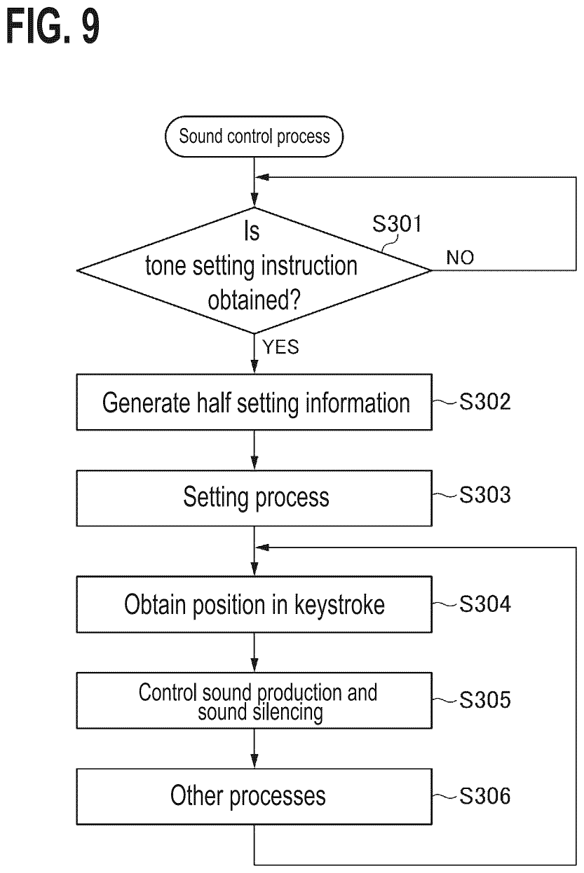

FIG. 9 is a flowchart of the sound control process. The process is carried out as the CPU 311 loads the program stored in the ROM 312 or the storage section 314 into the RAM 313 and executes the same. For instance, this process is triggered when the mode to generate sounds in conjunction with play of the instrument is switched on.

Firstly, at step S301, the CPU 311 waits until the tone setting instruction is obtained and proceeds to step S302 once the tone setting instruction is obtained. At step S302, the CPU 311 generates the half setting information J based on the tone setting instruction, in the same manner as the step S102 of FIG. 5.

At step S303, the CPU 311 carries out a setting process. Firstly, in the setting process, the CPU 311 configures the tone of sound to be produced in the sound source section 318, in accordance with a tone command identified by the half setting information J. Also, the CPU 311 configures the sound damping rates for different zones during a releasing stroke, according to the values for H1, H2, K1, and K2 as identified by the half setting information J. Further, the CPU 311 configures the prescribed sound effect identified by the half setting information J to be added for the half zone.

At steps S304 to S306, the CPU 311 carries out so-called, real-time play-responsive processing. Firstly, at step S304, the CPU 311 obtains a position in a keystroke. From the successively obtained positions in the keystroke, information on a velocity during a depression stroke or releasing stroke (in other words, a manipulation speed) is obtained as well.

At step S305, the CPU 311 controls sound production and sound silencing based on the position in the stroke and the half setting information J. Firstly, the CPU 311 creates audio signals based on the tone identified by the half setting information J and the obtained play information. The creation of the audio signals in this context takes place in the same manner as that of step S205 of FIG. 6. Further, the CPU 311 executes sound production and sound silencing processing through the sound emission section 320, which converts the created audio signals to sounds.

At step S306, the CPU 311 performs other processes before returning to step S304. The other processes referred to in this context involve responding to another detection of operation at the setting operator section 316 and executing a corresponding process. For instance, the CPU 311 returns to step S302 in response to the obtainment of another tone setting instruction (namely, an instruction to change tones). Alternatively, the CPU 311 ends the sound control process of FIG. 9 in response to receiving an input of an end command.

According to the instant embodiment, the tone setting instruction is obtained to generate the half setting information J in accordance with the tone setting instruction. Then, the position in the keystroke is obtained, and sound production and sound silencing are controlled based on the obtained position in the keystroke and the generated half setting information J. In this way, the manner in which sound is silenced during the releasing stroke is controlled in accordance with the tone setting instruction. Hence, analogous advantages to those of the first embodiment can be produced in connection with the fact that mute timings can be set as desired.

Different piano models from different manufacturers have different tones and half characteristics. According to each of the foregoing embodiments, however, the tones and half characteristics of a desired piano model can be virtually recreated in the course of production of sounds. That is, tones can be designated to reflect a tone unique to a given piano model and have the mute timings and half characteristics unique to that piano model recreated at the same time. For instance, if a given piano A is recognized to have a unique tone A of produced sounds, the tone A can be designated to apply the half setting information J with which to play the electronic keyboard instrument. In this way, not only are sounds produced in the tone A, but also the mute timings and half characteristics unique to the piano A are recreated in the production of the sounds.

It should be recognized that, from the viewpoint of providing variable mute timings and half characteristics, the half setting information J in each of the foregoing embodiments may be constituted by any information that can indicate the manner in which (in other words, a damping rate at which) produced sound is silenced as a function of a position in a keystroke—namely, for example, the function itself.

It should be noted that, when the half characteristics do not need to be variable, a single key-damper half point may be included without the values for H1 and H2 in the half setting information J. Alternatively, the values for K1 and K2 may be replaced with a single common value. Thus, it is not mandatory to provide a two-stage variable sound damping rate. Even in such scenarios, mute timings can still be set as desired in accordance with a set of tone commands.

It should also be understood that, from the viewpoint of providing a more simplified set-up, the coefficients K1 and K2 are rather not included in the half setting information J. That is, it is optional to make sound damping rates variable in accordance with a set of tone commands.

It should be noted that it is possible for the sound production trigger position to be varied in accordance with a set of tone commands. It should also be noted that the electronic keyboard instruments 200 and 300 may take either form of a grand piano or an upright piano.

It should be recognized that the tone setting instruction is merely one of the non-limiting examples of the “setting instruction” obtained by the obtainment sections 401 and 501. For instance, the instruction may configure a parameter other than a tone. That is, a user may designate variable mute timings and/or half characteristics without changing tones.

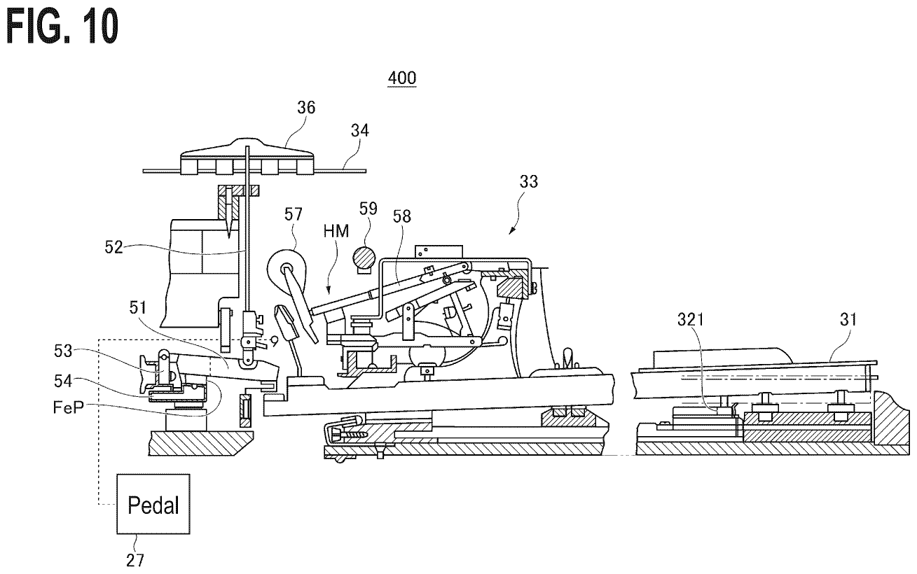

It should be understood that the present disclosure is also appliable to electronic keyboard instruments that include strings and action mechanisms, like the one illustrated in FIG. 10, and are capable of acoustic sound production. In other words, the electronic keyboard instrument 200 or 300 in each of the foregoing embodiments may be in the form of an electronic keyboard instrument 400 shown in FIG. 10. It should be noted that the electronic keyboard instrument 400 can include elements analogous to those of the electronic keyboard instrument 300 (FIG. 7).

FIG. 10 is a fragmentary cross-sectional view of the electronic keyboard instrument 400 that focuses on a single key to illustrate how the instrument is constructed. The electronic keyboard instrument 400 includes more than one key 31, an action mechanism 33 associated with a respective key 31, having a hammer HM, and configured to transmit the motion of the key 31 to the hammer HM, a string 34 configured to be struck by the hammer HM, and a damper 36 configured to stop the vibrations of the string 34.

The hammer HM includes a hammer shank 58 and a hammer head 57 and is pivoted, as a result of the depressing action on the key 31, to cause the hammer head 57 to strike a corresponding string 34 to thereby produce sound. A sensor 321 (FIG. 7) is provided for each key 31.

The electronic keyboard instrument 400 is provided with a pedal 27 in the form of a loud pedal (or a damper pedal) for actuating the damper 36. The damper 36 is provided for each key 31 except for higher notes. A damper lever 51 has a front part to which a damper wire 52 is coupled, and the damper wire 52 has an upper end to which the damper 36 is mounted. When the pedal 27 is pressed down, each damper 36 is lifted all at once. In contrast, when the key 31 is depressed in a non-pressed state of the pedal 27, only one damper 36 that is associated with the depressed key 31 is lifted.

The damper lever 51 is pivotably supported, at a rear end, by a damper lever flange 53. A lifting rail 54 is disposed below the damper lever 51. The lifting rail 54 extends horizontally for the widths of all of the keys, and is coupled to and supported on the pedal 27 through a push-up bar, which is not illustrated. The up-down motion of the pedal 27 will shift the push-up bar simultaneously, causing the lifting rail 54 to be vertically displaced accordingly.

As the lifting rail 54 is displaced upwards, a damper lever felt FeP acts on the damper lever 51 so that the damp lever 51 pivots in a counterclockwise direction in FIG. 10. This is how all dampers 36 are lifted through respective damper wires 52. Meanwhile, the damper lever 51 can be similarly pivoted in the counterclockwise direction in FIG. 10 when the key 31 is depressed. This time, however, only a damper 36 associated with that key 31 can be lifted and removed from the string 34 through the damper wire 52.

Moreover, the electronic keyboard instrument 400 includes a stopper 59. The stopper 59 is provided in common for all of the keys 31. The stopper 59 can be switched between a first position and a second position by being rotated. In the first position, the hammer shank 58 of the hammer HM does not hit the stopper 59 so that normal acoustic sound generation through vibrations of the string 34 is enabled. In the second position, the hammer shank 58 hits the stopper 59 before the hammer head 57 can strike the string 34 during a key depressing stroke.

Accordingly, the mode in which the stopper 59 is in the second position corresponds to a so-called silent mode, during which the string 34 is not struck by the hammer head 57. The sound production in the silent mode is initiated based on a sensing result from the sensor 321 during a depression stroke. The sound silencing is implemented based on a sensing result from the sensor 321 during a key releasing stroke. The sound control based on the half setting information J in each of the foregoing embodiments is deployed during the silent mode.

Note that a half zone in terms of tactile perception is not varied in the electronic keyboard instrument 400 whereas the half characteristics for sound production can be made variable, in accordance with the tone setting instruction. In this regard, a mechanism that allows the position in a keystroke, at which the damper 36 comes into contact with the string 34, to be varied may be provided, such that the mechanism is controlled based on the half setting information J to have a half zone in terms of tactile perception varied as well in accordance with the tone setting instruction. For example, in that scenario, a member, which couples the damper wire 52 and the damper lever flange 53 together, is provided with a mechanism that allows the position, at which the damper wire 52 and the damper lever flange 53 are coupled, to be varied. Moreover, an actuator, which is not shown, can be configured to actuate the mechanism based on the half setting information J to vary the coupling position.

It should be recognized that electronic keyboard instruments capable of acoustic sound production and in the form of upright pianos can also be adapted to additionally vary a half zone in terms of tactile perception in accordance with the tone setting instruction. For example, in that scenario, a damper spoon (not shown) may be configured to have a variable bend amount, with the bend amount of the damper spoon being configured to be varied by means of an actuator, which is not shown, based on the half setting information J.

It should be understood that the “half pedal zone” in terms of the relationship between the pedal 27 and the damper 36 can also be varied in accordance with the tone setting instruction. Put differently, the electronic keyboard instrument 400 may generate the half setting information J so as to include, in the half setting information J, second information defining a half pedal zone or a half pedal point for sound production for each of dampers associated with the plurality of keys 31. In that scenario, a piece of the half setting information J for the key-damper half zone and a piece of the half setting information J for the half pedal zone may be independently generated in such a way that the individual types of half zone control based on the tone setting instruction are concurrently applied.

It should be recognized that examples of electronic keyboard instruments, to which the present disclosure is applicable, include silent pianos with a sound source as well as keyboard instruments capable of automatic play with a drive mechanism for each key.

It should be noted that the MIDI signals discussed above can include signals complying with the MIDI 2.0 specifications.

It should be understood that the functional sections shown in FIGS. 4 and 8 may at least partially be implemented by AI (or Artificial Intelligence) in each of the forgoing embodiments.

While the present disclosure has been discussed thus far in detail on the basis of preferred embodiments of the same, these particular embodiments represent non-limiting embodiments of the present disclosure, and a variety of other configurations are also encompassed by the present disclosure to the extent that they do not depart from the principle of the present disclosure. The foregoing embodiments may also be partially combined with each other where appropriate.

It is worthwhile to note that a storage medium storing a control program represented by software for realizing the present disclosure can be loaded into the sound source, device, or instrument to produce similar advantages according to the present disclosure. In that case, one or more program codes read from the storage medium implement a set of novel functions of the present disclosure, and the non-transitory, computer-readable storage medium storing the program code(s) forms one aspect of the present disclosure. In some examples, the program code(s) may even be conveyed on a propagation medium. In that case, the program code(s) itself/themselves form(s) another aspect of the present disclosure. It should be noted that examples of the storage medium that can be used in these situations include a ROM, a diskette, a hard disk, an optical disk, a magneto-optical disk, a CD-ROM, a CD-R, a magnetic tape, and a non-volatile memory card. Examples of the non-transitory, computer-readable storage medium can even encompass entities that retain the program for a certain duration of time, such as volatile memories (for example, a DRAM (or Dynamic Random Access Memory)) within a computer system, which serves as a server and/or client used to transmit the program over a network such as the Internet and/or a communication line such as a telephone line.

What is claimed is:

1. A sound source comprising:
(i) one or more memories storing instructions and one or more processors configured to execute the instructions, (ii) one or more circuits, or both (i) and (ii) configured to:
obtain a setting instruction;
generate first information defining a key-damper half zone or a key-damper half point for sound production for each of a plurality of keys of an electronic keyboard instrument in accordance with the setting instruction; and
output the generated first information.

2. The sound source according to claim 1, wherein the generated first information defines a manner in which produced sound is silenced as a function of a position in a keystroke.

3. The sound source according to claim 1, wherein:
the setting instruction pertains to a tone setting; and
the generated first information includes information indicating a set of commands to configure a tone of sound played by the electronic keyboard instrument in accordance with the setting instruction.

4. The sound source according to claim 3, wherein the set of commands to configure the tone of sound include a command to add a sound effect for the key-damper half zone, in a case where the generated first information defines the key-damper half zone.

5. The sound source according to claim 1, wherein the (i) the one or more memories storing instructions and the one or more processors configured to execute the instructions, (ii) the one or more circuits, or both (i) and (ii) are further configured to:
create an audio signal based on (iii) the generated first information and (iv) play information generated as a result of the electronic keyboard instrument being operated; and
output the created audio signal.

6. The sound source according to claim 1, wherein the (i) the one or more memories storing instructions and the one or more processors configured to execute the instructions, (ii) the one or more circuits, or both (i) and (ii) are further configured to:
generate second information defining a half pedal zone or a half pedal point for sound production for each of a plurality of dampers respectively associated with the plurality of keys in accordance with the setting instruction; and
output the generated second information.

7. A computer-implemented method for controlling a sound source to perform a process, the process comprising:
obtaining a setting instruction;
generating first information defining a key-damper half zone or a key-damper half point for sound production for each of a plurality of keys of an electronic keyboard instrument in accordance with the setting instruction; and
outputting the generated first information.

8. A non-transitory computer-readable storage medium storing a program executable by at least one processor of a computer system to control a sound source to perform a process, the process comprising:
obtaining a setting instruction;
generating first information defining a key-damper half zone or a key-damper half point for sound production for each of a plurality of keys of an electronic keyboard instrument in accordance with the setting instruction; and
outputting the generated first information.

9. An electronic keyboard instrument comprising the sound source according to claim 1.

10. An electronic keyboard instrument comprising the sound source according to claim 2.

11. An electronic keyboard instrument comprising the sound source according to claim 3.

12. An electronic keyboard instrument comprising the sound source according to claim 4.

13. An electronic keyboard instrument comprising the sound source according to claim 5.

14. An electronic keyboard instrument comprising the sound source according to claim 6.

15. An electronic keyboard instrument comprising:
a plurality of keys; and
(i) one or more memories storing instructions and one or more processors configured to execute the instructions, (ii) one or more circuits, or both (i) and (ii) configured to:
obtain a setting instruction;
generate first information defining a key-damper half zone or a key-damper half point for sound production for each of the plurality of keys in accordance with the setting instruction;
obtain a position in a keystroke of a key among the plurality of keys; and
control sound production and sound silencing based on the obtained position in the keystroke and the generated first information.

16. The electronic keyboard instrument according to claim 15, wherein the (i) the one or more memories storing instructions and the one or more processors configured to execute the instructions, (ii) the one or more circuits, or both (i) and (ii) are configured to:
control the sound silencing after the position in the keystroke of the key reaches the key-damper half zone or goes past the key-damper half point during a key releasing stroke of the key.

17. The electronic keyboard instrument according to claim 15, wherein the (i) the one or more memories storing instructions and the one or more processors configured to execute the instructions, (ii) the one or more circuits, or both (i) and (ii) are further configured to:
generate second information defining a half pedal zone or a half pedal point for sound production for each of a plurality of dampers respectively associated with the plurality of keys in accordance with the setting instruction; and
control the sound production and the sound silencing based on the obtained position in the keystroke, the generated first information, and the generated second information.
